(19) United States
(12) Patent Application Publication
(10) Pub. No.: US 2005/0175812 A1
(43) Pub. Date: Aug. 11, 2005

(54) Tablecloth convertible to garbage bag

(76) Inventor: Al Said M. Mohammed, Tampa, FL (US)

Correspondence Address: Richard C. Litman;LITIMAN LAW OFFICES, LTD., P.O. Box 15035, Arlington, VA, 22215, US

(21) Appl. No.: 10/773,428

(22) Filed: Feb. 9, 2004

(51) Int. Cl. B32B 3/06

(52) U.S. Cl. 428/99

(57) ABSTRACT

A tablecloth convertible to a garbage bag. The disposable tablecloth includes a flexible panel having a peripheral edge, the panel being bunched along its peripheral edge and having an elastic band attached along its length to form an expandable edge. The elastic band is of such length that the flexible panel forms a tablecloth upon the expandable edge being expanded such that said flexible panel is stretchable over a table top, the flexible panel closing over and partially encasing the table top upon said elastic band returning to its retracted position. There are at least two opposed handles attached to the expandable edge of the flexible panel forming the tablecloth. Upon completion of a meal, the remaining trash is left in place on the tablecloth surface and the expandable edge pulled outward and upward over the table, forming a bag over the trash. The bag is then carried for disposal.

### BACKGROUND OF THE INVENTION

1. Field of the Invention

The present invention relates to tablecloths. More particular, the present invention relates to a tablecloth which is convertible to a garbage bag for holding trash and garbage remaining from meal.

2. Description of the Related Art

Much time and effort is expended in clearing a table of utensils, trash and garbage after a meal. In a casual cafe dining setting where utensils are of the disposable type, significant time and effort is still expended in the process of preparing the table for future diners, including removal of the trash to a container, wiping down the table, and transport of the trash in the container to a garbage can. During the removal or “bussing” operation, leftover food and drink may easily be spilled, requiring further effort in cleaning the surrounding floor and seating. Even where tablecloths or covers are replaced between diners, there is substantial risk of spillage which requires time and labor and is unsightly to other diners

The containment of such trash and garbage in a picnic or patio setting where a table is employed is an unwanted chore which detracts from the enjoyment of the outing or meal. Also, the accidental spillage of trash or garbage may be difficult to clean up and trash and garbage must be transferred to a separate container or trash bag for removal from the picnic or patio site. The use of disposable tablecloths which are used to contain the trash and garbage remaining from a meal is known.

Known tablecloths of this type require a drawstring which must be pulled to form one or more loops for closing and carrying the resulting trash bag. Such tablecloths either require the drawing of the drawstring underneath the table, which is a clumsy operation, or leave the drawstring visible to the diners, detracting from the appearance of the tablecloth and making them easily reachable by children who may pull the drawstring at an inopportune time. Known designs providing for drawstrings are inherently relatively expensive to make and assemble.

It would be desirable to provide a disposable tablecloth usable as a bag for trash and garbage remaining on the tablecloth after dining is complete in which a drawstring or similar cord is not required. It would also be desirable to provide such a tablecloth which does not extend downward a substantial distance from the table top, thus providing a neat fit to the table top and minimizing material required in the construction of the disposable tablecloth.

U.S. Pat. No. 4,895,742, issued Jan. 23, 1990, to Schaub et al., describes a convertible receptacle useful as a tablecloth which has two separable layers, the upper layer having a slit for receiving trash from dining and having drawstrings for converting to a trash receptacle.

U.S. Pat. No. 4,938,607, issued Jul. 3, 1990, to Kelley, describes a thermoplastic sheet having draw tape within peripheral hems useful as a disposable tablecloth and trash container.

U.S. Pat. No. 5,069,554, issued Dec. 3, 1991, to Bonnett describes a tablecloth disposal system having a cinch strap in a peripheral hem, the hem in one embodiment including an accordion style folded wall beneath the hem.

U.S. Pat. No. 5,219,219, issued Jun. 15, 1993, to Virdin, Jr., describes a trash bag table cover having two layers having a peripheral drawstring and a securable slit in the upper layer to receive trash.

U.S. Pat. No. 5,339,748, issued Aug. 23, 1994, to Bilotti, describes a table cover having an elastic band for loosely holding the cover over a table tops of various sizes, and a drawstring to provide a tight fit over a particular table, and note column 1, lines 22-36 where table covers are discussed which are provided with an elastic band secured along the peripheral edges to allow the table cover to conform to the table top.

U.S. Pat. No. 4,337,812, issued Jul. 6, 1982, to Trinkner, describes a combined picnic bag and tablecloth where a tablecloth has a pocket for utensils and a surrounding hem and a draw cord for drawing the tablecloth into the form of a bag for carrying picnic items.

U.S. Pat. No. 4,500,129, issued Feb. 19, 1985, to Hahn, describes a protective pad having fasteners at the corners to form a lip around the pad and has handles at two opposed corners for carrying the folded pad.

None of the above inventions and patents, taken either singly or in combination, is seen to describe the instant invention as claimed. Thus a tablecloth convertible to a garbage bag solving the aforementioned problems is desired.

### SUMMARY OF THE INVENTION

The present invention is a tablecloth convertible to a garbage bag. The tablecloth includes a flexible panel having a peripheral edge, the panel being bunched along its peripheral edge and having an elastic band attached along its length to form an expandable edge. The elastic band is of such length that the flexible panel forms a tablecloth upon the expandable edge being expanded such that said flexible panel is stretchable over a table top, the flexible panel closing over and partially encasing the table top upon said elastic band returning to its retracted position.

There are at least two opposed handles attached to the expandable edge of the flexible panel forming the tablecloth. Upon the tablecloth having trash and garbage remaining from a meal thereon, the flexible panel converts to a garbage bag by stretching its expandable edge over the periphery of the table top and removing the cloth from the table while enclosing the trash and garbage, the garbage bag being carried by said handles to a place for disposal. The handles may be tied together to secure the trash for disposal.

The tablecloth is generally circular in shape, but may fit over any shape tabletop. The convertible tablecloth is preferably made from two-ply polymeric sheet material such as that used in conventional garbage bags, preferably polyvinyl sheet material. The handles may be plastic strips attached at each end to the peripheral edge of the flexible panel at the attachment of the elastic band. The plastic strips may be folded over the peripheral edge and heat welded or sewn in place.

The present invention provides improved elements and arrangements thereof for the purposes described which is inexpensive, dependable and fully effective in accomplishing its intended purposes.

These and other features of the present invention will become readily apparent upon further review of the following specification and drawings.

### BRIEF DESCRIPTION OF THE DRAWINGS

FIG. 1 is an environmental, perspective view of the convertible tablecloth according to the present invention.

FIG. 2 is a plan view of the convertible tablecloth as mounted on a round table top.

FIG. 3 is a bottom view of the round table top as covered by the convertible table top of FIG. 1.

FIG. 4 is a detail view of FIG. 3, showing a bunched elastic tablecloth perimeter portion with an attached handle.

FIG. 5 is an environmental elevation view of the tablecloth of FIG. 1 carried in trash bag mode by handles as in FIG. 4.

Similar reference characters denote corresponding features consistently throughout the attached drawings.

### DETAILED DESCRIPTION OF THE PREFERRED EMBODIMENT

The present invention is a tablecloth convertible to a garbage bag. The tablecloth includes a flexible panel having a peripheral edge, the panel being bunched along its peripheral edge and having an elastic band attached along its length to form an expandable edge. The elastic band is of such length that the flexible panel forms a tablecloth upon the expandable edge being expanded such that said flexible panel is stretchable over a table top, the flexible panel closing over and partially encasing the table top upon said elastic band returning to its retracted position. There are at least two opposed handles attached to the expandable edge of the flexible panel forming the tablecloth.

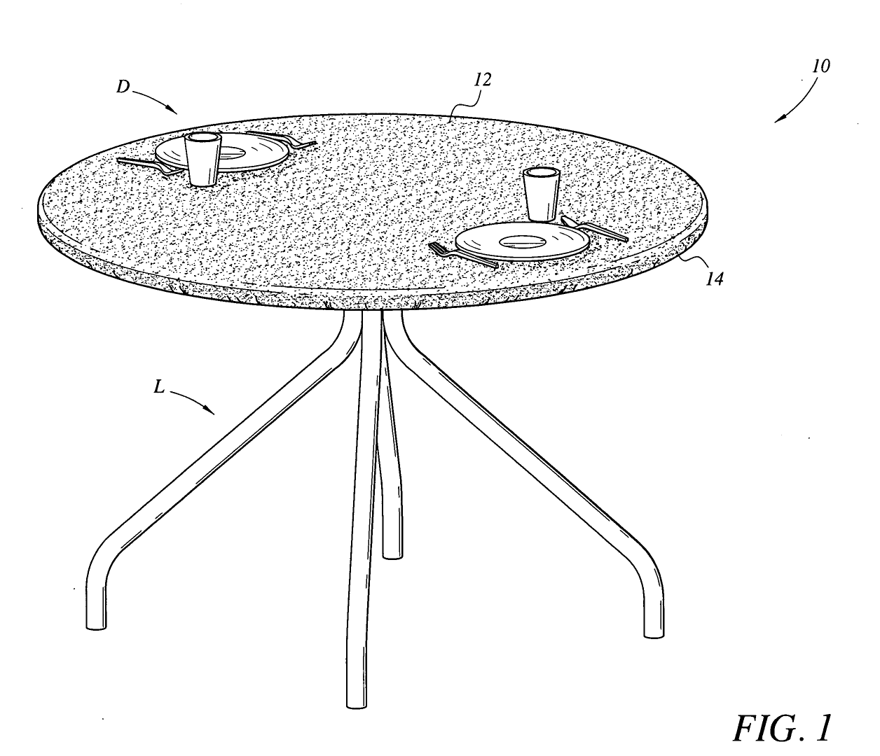

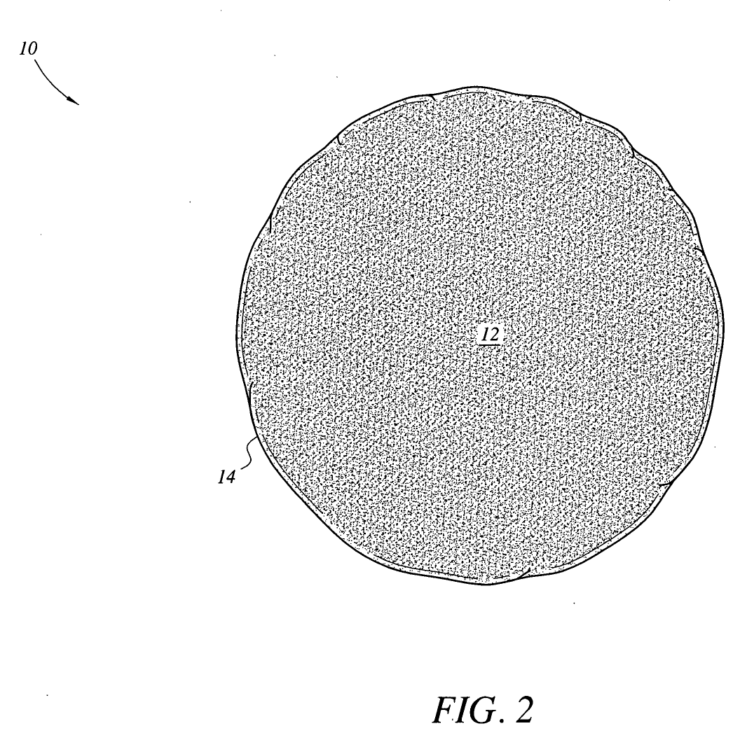

Referring to the Figures, there is shown a convertible tablecloth and garbage bag system according to the present invention generally referred to by the reference number 10. Convertible tablecloth and garbage bag system 10 includes a tablecloth 12 of flexible sheet material having a periphery 14 (see FIGS. 1 and 2) extended around the top of a table T. Although Table T is shown as having a round top, the tablecloth and garbage bag system 10 may be applied to other shapes of top such as square, rectangular, and hexagonal. Disposable dinnerware may be located on top of the tablecloth-covered table T.

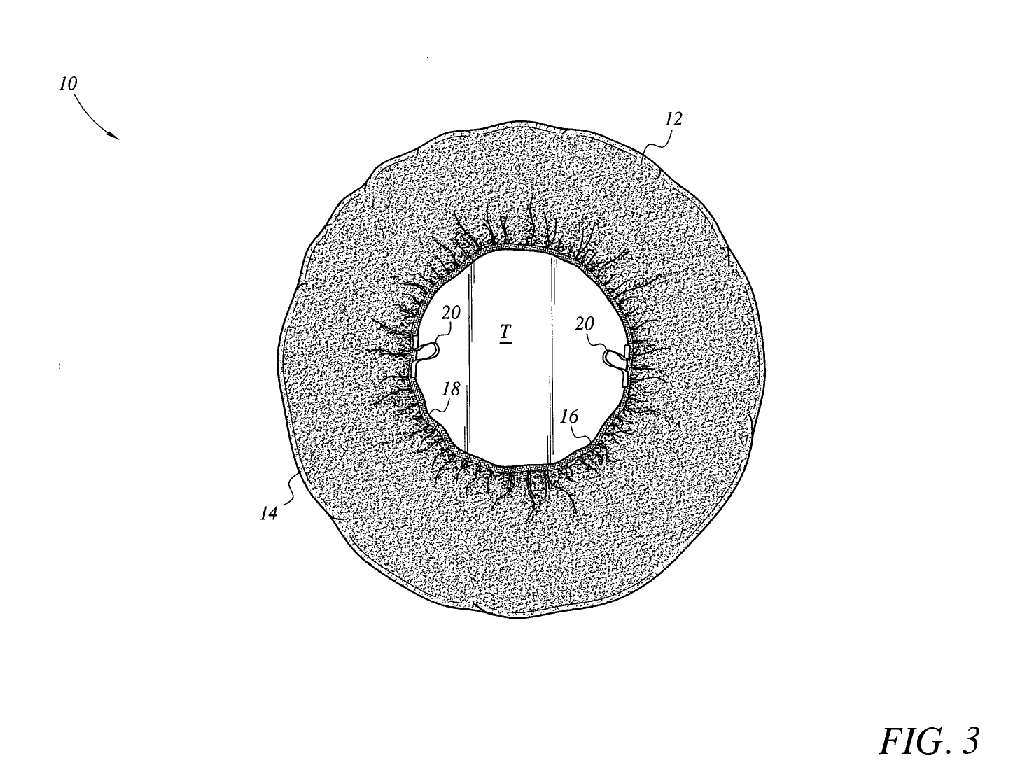

Referring to FIG. 3, there is shown the underside of a round embodiment of the invention where convertible tablecloth 12 extends inward from periphery 14 to elastic edge 16. An elastic strip 18 is applied around the peripheral edge of the flexible sheet material to form elastic edge 16 by sewing or in another known manner and the edge bunched along the elastic edge 16 so as to expand upon expansion of the elastic edge 16 by pulling by the user. Straps 20 are located on the elastic edge 16 in any desired number, and preferably on opposing sides of the elastic edge. These may be useful in pulling the elastic edge during mounting and removing the tablecloth 12 from the top of table T. The tablecloth 12 may be removed from the top of table T by pulling outward and then upward on the elastic edge 16, allowing tablecloth 12 to be removed from the top of table T. In this manner, upon completion of the meal, the remaining utensils D and food scraps may be captured by the convertible tablecloth 12 by lifting the elastic edge 16 to a level above the top of table T such as to turn the tablecloth 12 inside out. The tablecloth 12 is thereby converted into a garbage or trash bag containing the used throwaway utensils T and food scraps.

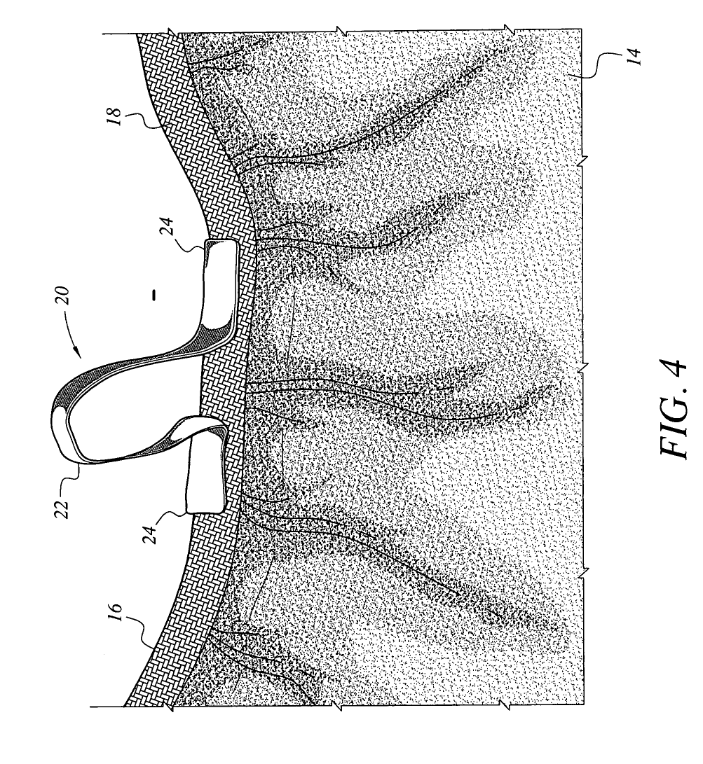

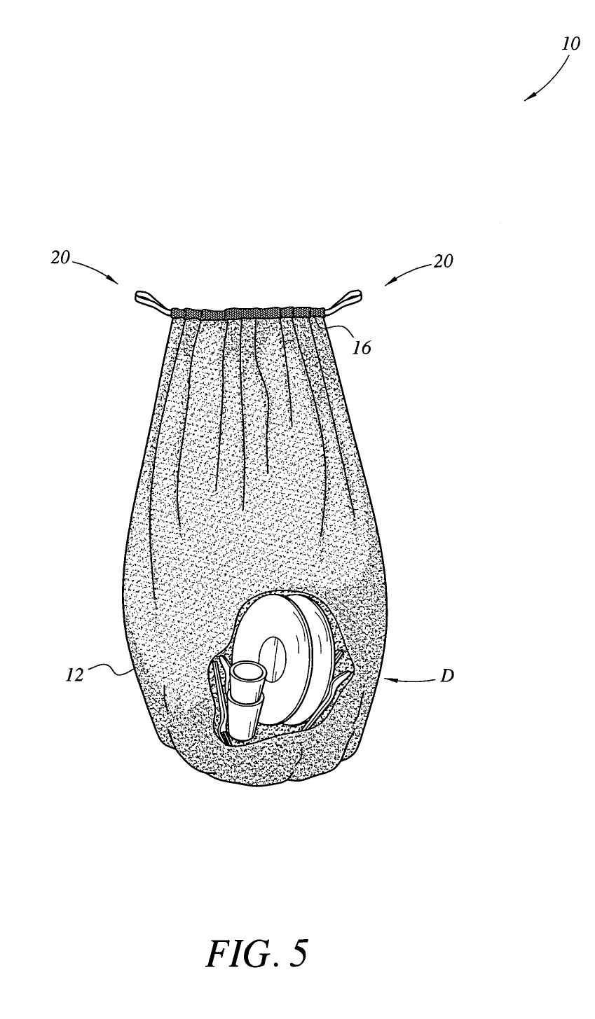

Referring to FIGS. 4 and 5, there is shown a detail of one of the straps 20 as attached to the elastic edge 16 forming a handle 22, and the resulting bag as carried by the straps 20 in the fully converted configuration, respectively. The straps may be made of plastic strips which have a center hand-held handle portion 22 and attached at each end by strap attachment portions to the tablecloth 12 at elastic edge 16 to form handles. The plastic strips 20 are preferably connected to the table cloth 12 at the elastic edge 16 by any convenient manner such as heat sealing or sewing, the ends thereof being folded over the elastic edge or attached at the side surface of tablecloth 12 at the edge 16, as desired.

In use, tablecloth 12 is placed on the top of a table T by stretching the elastic edge 16 and pulling the tablecloth 12 over the perimeter edge of the top of table T. The tablecloth 12 is then straightened and arranged so as to form a smooth covering for table T. Disposable dining ware D is placed on the tablecloth 12 and the dining or picnic is carried out. Upon finishing eating, the user simply pulls the elastic edge 16 outward and upward, trapping the dining ware D and any food scraps as the convertible tablecloth 12 is converted into a garbage or trash bag configuration. The straps 20 are then grasped by the user and the bag containing the dining ware D and any food straps is carried to a point of disposal. The straps 20 may be tied together before disposal to help avoid any spillage of contents during the disposal process.

The sheeting of the tablecloth may be made of any desired sheet or film material such a vinyl or polyester and is preferable two-ply for strength. The straps may be made of the same material as the sheets or an alternative material as desired.

It is to be understood that the present invention is not limited to the embodiment described above, but encompasses any and all embodiments within the scope of the following claims.

1. A tablecloth convertible to a garbage bag, comprising:
a flexible panel having an expandable peripheral edge, said panel being bunched along its peripheral edge and having an elastic band attached to and surrounding said peripheral edge to form said expandable edge, said elastic band being of such length that said flexible panel forms a tablecloth, said elastic band being expandable such that said flexible panel is stretchable over a table top, said flexible panel closing over said table top upon said elastic band returning to its retracted position; and
at least two spaced handles attached to said flexible panel proximate said expandable edge;
whereby, upon said tablecloth having trash and garbage remaining from a meal thereon, said flexible panel converts to a garbage bag by stretching its expandable over said table to and enclosing said trash and garbage, said garbage bag being carried by said handles to a place for disposal.

2. The convertible tablecloth of claim 1, wherein said flexible panel is circular in shape.

3. The convertible tablecloth of claim 2, wherein there are two handles located at opposed positions on said flexible panel and said handles are attached to said expandable edge.

4. The convertible tablecloth of claim 3, wherein said flexible panel is two-ply polymeric sheet.

5. The convertible tablecloth of claim 4, said polymeric sheet being polyvinyl or polyester sheet.

6. The convertible tablecloth of claim 5, each said handle comprising a polymeric strip having attachment end portions and a grasping portion, said attachment end portions being attached to said expandable edge.

7. The convertible tablecloth of claim 6, wherein said attachment end portion of said polymeric strip is attached to said expandable edge by heat-welding.
